(19) United States
(12) Patent Application Publication
(10) Pub. No.: US 2023/0419934 A1
(43) Pub. Date: Dec. 28, 2023

(54) RESPONSIVE LIVE MUSICAL SOUND GENERATION

(71) Applicant: INTERNATIONAL BUSINESS MACHINES CORPORATION, ARMONK, NY (US)

(72) Inventors: Killian Levacher, Dublin (IE); Stefano Braghin, Dublin (IE); Marco Simioni, Dublin (IE); Ambrish Rawat, Dublin (IE)

(21) Appl. No.: 17/809,173

(22) Filed: Jun. 27, 2022

(51) Int. Cl. G10H 1/36; G10H 1/00; G10L 13/033

(52) U.S. Cl. CPC G10H 1/361; G10H 1/0083; G10L 13/0335; G10H 2210/005; G10H 2250/455

(57) ABSTRACT

Predetermined musical data for a song is received. The predetermined musical data includes chords and lyrics and rhythmic structures of the song. Audio data of a band generating music of the song is received. Generating real-time vocal audio that is in rhythm with the audio data and in harmony with the chords. The vocal audio includes the lyrics and is of a predetermined voice.

### BACKGROUND

Deepfakes or synthetic media are growing in ubiquity and ability. For example, there are increasing applications to generate a realistic depiction of a human doing a thing. As deepfakes continue to be developed, it is getting harder and harder to distinguish deepfakes from reality.

### SUMMARY

Aspects of the present disclosure relate to a method, system, and computer program product relating to responsive musical sound generation. For example, the method includes receiving predetermined musical data for a song, where the predetermined musical data includes chords and lyrics and rhythmic structures of the song. The method also includes receiving audio data of a band generating music of the song. The method also includes generating real-time vocal audio that is in rhythm with the audio data and in harmony with the chords, wherein the vocal audio includes the lyrics and is of a predetermined voice. A system and computer program configured to execute the method described above are also described herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of an example system in which controller may dynamically respond to received audio data with generated real-time vocal and instrumental data according to predetermined musical data.

FIG. 2 depicts a conceptual box diagram of example components of the controller of FIG. 1.

FIG. 3 depicts an example flowchart by which the controller of FIG. 1 generates responsive real-time vocal data.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to generating vocal and/or instrumental data, while more particular aspects of the present disclosure relate to receiving audio data of a live band and then dynamically responding to this audio data with vocal and instrumental data that synchronizes with the audio data of the band in real-time according to predetermined musical data. While the present disclosure is not necessarily limited to such applications, various aspects of the disclosure may be appreciated through a discussion of various examples using this context.

Music (and the groups that perform this music) are a fundamental pillar of every culture. Across cultures, there is a steady demand for certain pieces of music to be performed, particularly in certain manners, and/or as performed by certain artists. Though some songs and artists only enjoy a relatively brief time period during which they attract interest from the public, other songs and/or artists experience demand for their music continuing (and/or increasing) for many decades. Accordingly, if these artists become unable to perform their songs according to their historical norms for any reason, it may become functionally impossible to experience what it was like to listen to these artists in a live format, such as at a concert or the like. For example, even if contemporary artists wish to include the voice or instrumental style of an artist that is no longer able to perform, the contemporary artist may only be able to do so by playing recordings, and/or by attempting to recreate these performances with separate artists.

Aspects of this disclosure provide the ability to generate performances of known artists in a live and responsive format. For example, aspects of this disclosure relate to automatically generating live raw voice and/or instrument sound as matched with graphical “avatar” output that is synchronized with a live band. One or more computing devices that include one or more processing units executing instructions stored on one or more memories may provide the functionality that addresses these problems, where said computing device(s) are herein referred to as a controller.

For example, this controller could take as input such information as a score (consisting of a set of chords, a melody line, text lyrics, or the like), a set of voices and/or instruments to generate, live sound from a band (e.g., midi output or raw sound), visual queues from the band (e.g., a nod from a bandmate to initiate and/or stop vocal and/or instrumental generation), and/or data regarding whether to generate vocal and/or instrumental audio based on melody input or improvisation. Further, the controller could use this input to provide such output as raw vocal audio and/or instrument data that is synchronized with the live band as well as a graphical depiction of a singer (e.g., an avatar) that is lip synching with the generated vocal audio and/or is graphically depicted as playing the instrument of the instrument audio data.

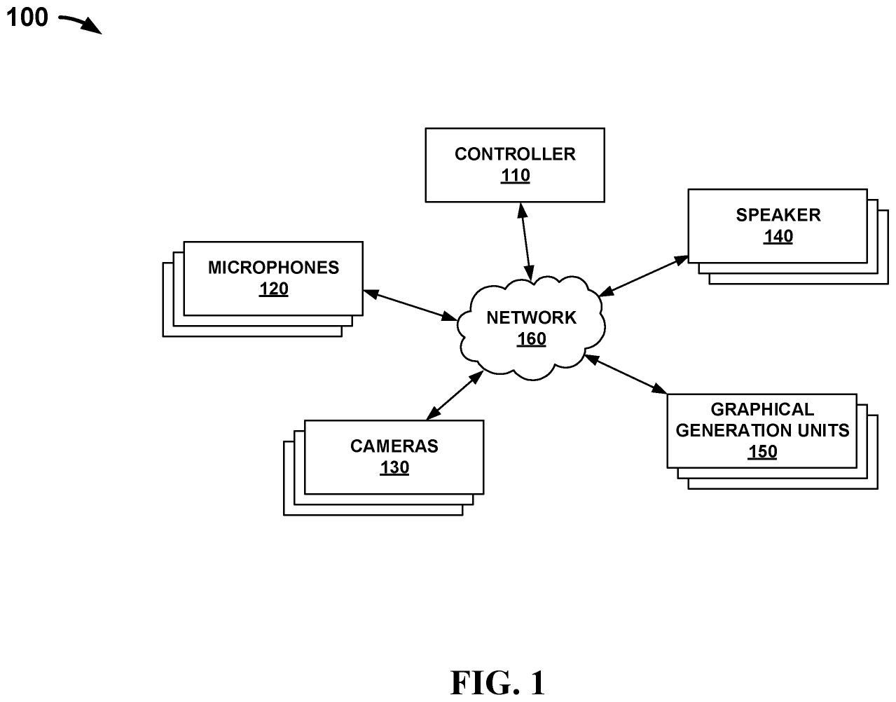

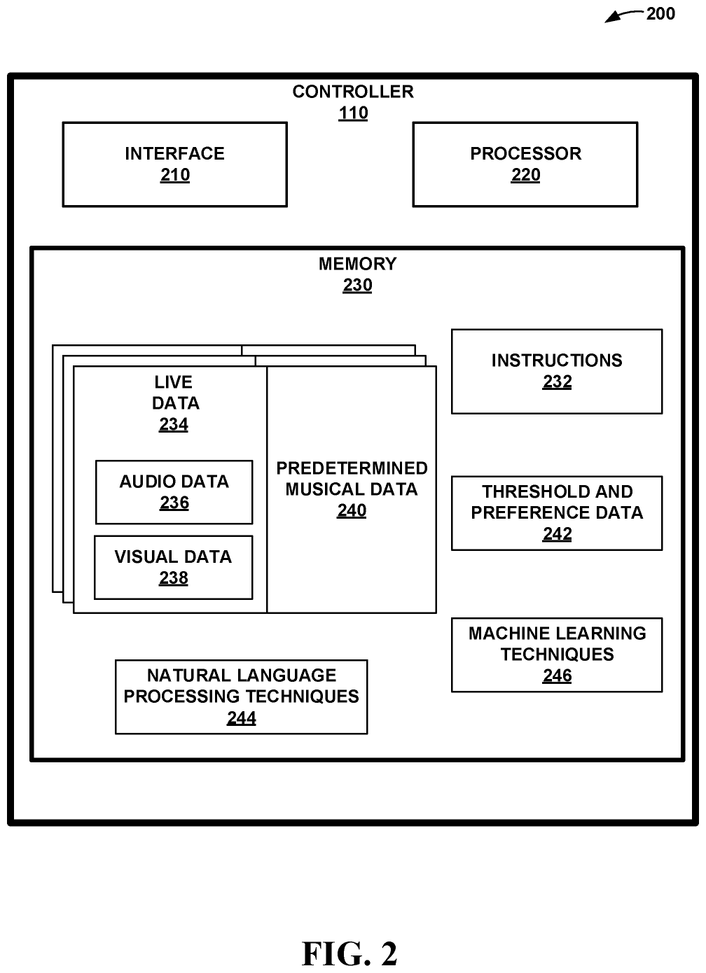

For example, FIG. 1 depicts environment 100 in which controller 110 generates vocal and/or instrumental data responsive to (and synchronized with) a live band. Controller 110 may include a processor coupled to a memory (as depicted in FIG. 2) that stores instructions that cause controller 110 to execute the operations discussed herein. Though controller 110 is depicted as being structurally distinct from components such as microphones 120, cameras 130, speakers 140, and graphical generation units 150, in some embodiments some or all of these components could be integrated into controller 110.

Environment 100 may include a life performance hall, such as a concert hall, stadium, club, or the like. As depicted, controller 110 may be configured to interact with one or more microphones 120, one or more cameras 130, one or more speakers 140, and one or more graphical generation units 150. For example, controller 110 may be electronically coupled to these different components over network 160. Network 160 may include a computing network over which computing messages may be sent and/or received. For example, network 160 may include the Internet, a local area network (LAN), a wide area network (WAN), a wireless network such as a wireless LAN (WLAN), or the like. Network 160 may comprise copper transmission cables, optical transmission fibers, wireless transmission, routers, firewalls, switches, gateway computers and/or edge servers. A network adapter card or network interface in each computing/processing device (e.g., computing devices that host/include controller 110, microphones 120, cameras 130, speaker 140, and/or graphical generation units 150) may receive messages and/or instructions from and/or through network 160 and forward the messages and/or instructions for storage or execution or the like to a respective memory or processor of the respective computing/processing device. Though network 160 is depicted as a single entity in FIG. 1 for purposes of illustration, in other examples network 160 may include a plurality of private and/or public networks.

Controller 110 may first receive predetermined musical data. For example, controller 110 may receive a full musical catalog performed by a band or artist. Controller 110 may ingest this music to identify profiles of one or more singers and/or instrumentalists of the band. This may include controller 110 learning what an artist sounded like, what their strengths were, what their weaknesses were, what their tendencies were, or the like.

In some examples, controller 110 may also receive specific instructions along with this predetermined musical data. For example, while controller 110 may receive a full musical catalogue, controller 110 may be instructed to construct the vocal profile using the timbre of a singer when the singer was young (e.g., in their 20s and 30s) rather than when the singer was older (e.g., in their 60s and 70s). For another example, controller 110 may be instructed to specifically avoid some iterations of live songs, such as some specific historical improvisations. Controller 110 may eventually generate (or otherwise receive, in embodiments where this profile is generated externally to controller 110) a full vocal and/or instrumental profile of one or more members of a band, such that controller 110 can generate audio output that realistically mimics the sound of a particular singer singing and/or a particular instrumentalist playing an instrument.

Controller 110 may further be given video footage of members of the band. For example, controller 110 may be fed numerous videos of a singer. This may include video of the singer singing from numerous angles, sometimes including a concert where the singer was recorded from multiple angles at the same moment in time. From this footage, controller 110 may construct (or otherwise receive, in embodiments where this profile is generated externally) an avatar that mimics the three-dimensional appearance and mannerisms of the person of the captured vocal profile. This may include controller 110 matching the way in which the particular person looks as they sing, play an instrument, or the like.

At this point, controller 110 may generate live vocal and/or instrumental audio that is synchronized with a live band. For example, controller 110 may receive audio data from one or more microphones 120 positioned around environment 100, and/or controller 110 may receive video data from one or more cameras 130 positioned around environment 100. These microphones 120 may include microphones 120 of the sound system providing the audio for the concert. In some example, controller 110 may receive and/or control a live video feed from respective cameras 130 tracking each member of the band.

Controller 110 may detect that it is time to start generating live vocal and/or instrumental audio in response to one or more queues from microphones 120 and/or cameras 130. For example, controller 110 may detect a band member nodding in beat for four beats, indicating that on the next down beat instrumental audio should be generated. Further, controller 110 may consult provided predetermined musical data (e.g., information provided before the concert, such as concert notes and/or sheet music that includes chords, lyrics, rhythmic structures, or the like) to identify a “set list” for the concert, therein identifying what instrumental audio to provide. Controller 110 may further use the predetermined musical data to identify the point at which vocal audio is to be provided based on the progression of the song.

Controller 110 may generate this vocal and/or instrumental audio via one or more speakers 140. For example, in some situations controller 110 will exclusively provide this audio directly into the master system, such that the only source of this vocal and/or instrumental audio is from the master sound system. In other examples, controller 110 will both pipe the vocal and/or instrumental audio into the master sound system while also generating a representative amount of audio into a respective area of the stage (e.g., an area of the stage that corresponds to the location of the avatar). For example, at a relatively smaller venue (e.g., such as a small club), it may feel unrealistic if the only audible sound of the generated avatar is coming through speakers 140 around environment 100, such that controller 110 provides a “normal” (e.g., non-amplified) version of the vocal and/or instrumental audio on the stage.

Controller 110 may generate a graphical depiction of the particular person for whom vocal and/or instrumental audio is being generated. For example, controller 110 may generate a realistic avatar of that particular band member, where this avatar depicts the relevant member of the band using graphical generation units 150. This may include controller 110 generating this depiction on graphical generation units 150 of screens, and/or graphical generation units 150 of hologram generators. For example, controller 110 may generate a hologram using graphical generation units 150 for a 3D depiction of the band member, but may also generate a 2D version of the band member on massive screens (e.g., to correct for the fact that the hologram might look worse when projected across a 50 foot tall screen as compared to projected to be 6 feet tall and viewed from 100 feet away). In such examples, controller 110 may edit out the hologram within the video feed provided on monitors to better provide the avatar as depicted in 2D.

Controller 110 creates these graphical depictions such that they align with the generated vocal and/or instrumental audio. For example, controller 110 may generate a full-body hologram of a lead singer that is walking around the stage, holding a microphone, waving, or the like in a way that is both accurate to the actual lead singer and also that aligns with the generated audio.

Controller 110 may generate the graphical depiction and vocal/instrumental audio such that it is responsive to stimuli of the environment. For example, controller 110 may detect the crowd getting louder, in response to which controller 110 may cause the avatar to raise its arm to acknowledge and invigorate the crowd. For another example, controller 110 may detect some stimuli in the crowd that other members of the band are looking at (e.g., someone crowd surfing), and may cause the avatar to look in this same direction. For yet another example, controller 110 may detect a person fainting or collapsing in the front row of the stands, in response to which controller 110 may cause the avatar to stop “performing” and instead tell the crowd to give the relevant person in the crowd some space, or ask for help (e.g., in some cases the controller 110 may also immediately call authorities electronically to inform of the person in distress). In this way, controller 110 may respond to myriad examples of stimuli in a way that causes audio output to synchronize with visual output (e.g., such that the avatar lips are synched up with the vocal output) while also being consistent with the identified profiles (e.g., visual profile, audio profile, general character profile) of the respective band member.

Controller 110 may dynamically respond to queues from the band in generating music. For example, controller 110 may detect if one member of the band is improvising, and may improvise along musically (whether with singing or instrument), cause the avatar to dance, or simply wait until the detected improvisational period is over. For another example, controller 110 may detect how the swell of a song is growing such that the end of a song is approaching, and may hold a vocal or instrumental note until the moment that it is detected that other members of the band are going to end it.

As described above, controller 110 may include or be part of a computing device that includes a processor configured to execute instructions stored on a memory to execute the techniques described herein. For example, FIG. 2 is a conceptual box diagram of such computing system 200 of controller 110. While controller 110 is depicted as a single entity (e.g., within a single housing) for the purposes of illustration, in other examples, controller 110 may include two or more discrete physical systems (e.g., within two or more discrete housings). Controller 110 may include interface 210, processor 220, and memory 230. Controller 110 may include any number or amount of interface(s) 210, processor(s) 220, and/or memory(s) 230.

Controller 110 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with microphones 120, cameras 130, speaker 140, graphical generation units 150, or the like. Interface 210 may include one or more network interface cards, such as Ethernet cards and/or any other types of interface devices that can send and receive information. Any suitable number of interfaces may be used to perform the described functions according to particular needs.

As discussed herein, controller 110 may be configured to dynamically generate real-time vocal and/or instrumental data for a live performance that is synchronized with a live band. Controller 110 may utilize processor 220 to generate real-time vocal and/or instrumental data in this way. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to generate real-time vocal and/or instrumental data accordingly.

Processor 220 may generate vocal data according to instructions 232 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may generate real-time responsive vocal and/or instrumental data as described herein according to instructions 232 of one or more applications (e.g., software applications) stored in memory 230 of controller 110.

In addition to instructions 232, in some examples gathered or predetermined data or techniques or the like as used by processor 220 to generate real-time vocal and/or instrumental data as described herein may be stored within memory 230. For example, memory 230 may include information described above that is gathered from environment 100. Specifically, as depicted in FIG. 2, memory 230 may include live data 234, which itself includes audio data 236 and visual data 238, and memory 230 may also include predetermined musical data 240. Live data 234 may include all data that is gathered live at a venue from environment 100 (e.g., gathered from microphones 120 and cameras 130). Data gathered by controller 110 from microphones 120 may be stored as audio data 236, where data gathered from cameras 130 may be stored as visual data 238. Controller 110 may analyze and synthesize these two streams of data to identify queues with which to modify the generated vocal (and/or instrumental) data. For example, controller 110 may default to generating vocal data exactly according to predetermined musical data 240, but controller 110 may modify the generated vocal data according to live data 234 to ensure that the vocal data is synchronized with the band.

Further, memory 230 may include threshold and preference data 242. Threshold and preference data 242 may include thresholds that define a manner in which controller 110 is to manage generate the vocal data. For example, threshold and preference data 242 may include thresholds at which controller 110 modify vocal data to speed up, slow down, improvise, or the like. Threshold and performance data 242 may include a significant number of thresholds, such that for a first song controller 110 is to rarely/never modify the generated vocal data away from the parameters of the predetermined musical data 240, whereas for other songs controller 110 is given significant ability to modify the generated vocal data per various queues within the live data 234, whereas for other songs there are some portions that should strictly adhere to predetermined musical data 240 while other portions are allowed to be significantly modified.

Memory 230 may further include natural language processing (NLP) techniques 244. NLP techniques 244 can include, but are not limited to, semantic similarity, syntactic analysis, and ontological matching. For example, in some embodiments, processor 220 may be configured to analyze natural language data of audio data 236 or the like as gathered by microphones to determine semantic features (e.g., word meanings, repeated words, keywords, etc.) and/or syntactic features (e.g., word structure, location of semantic features in headings, title, etc.) of natural language data being spoken by members of the band or audience. Ontological matching could be used to map semantic and/or syntactic features to a particular concept. The concept can then be used to identify explicit or implicit queues within audio data 236. For example, controller 110 may use NLP techniques 244 to detect a band member discuss what song they are singing next, and use this to bring up relevant predetermined musical data 240. For another example, controller 110 may use NLP techniques to detect a member of the audience yell “I love you [band name],” or “I love you [particular singer],” in response to which controller 110 may cause the vocal audio to proclaim “we love you [city name].”

Memory 230 may further include machine learning techniques 246 that controller 110 may use to improve a process of generated live vocal data as described herein over time. Machine learning techniques 246 can comprise algorithms or models that are generated by performing supervised, unsupervised, or semi-supervised training on a dataset, and subsequently applying the generated algorithm or model to generate real-time vocal data that is synchronized with a live band. Using these machine learning techniques 246, controller 110 may improve an ability to dynamically generate vocal data that is synchronized with the band and feels organic to the environment. For example, controller 110 may identify over time certain types of modifications that improve or decrease synchronization (e.g., when to slow down or speed up vocal output), and may further learn what types of modifications cause positive audience reactions (e.g., cause the audience to cheer, to clap, to laugh) and/or limit negative audience reactions (e.g., the audience suddenly getting unexpectedly quiet, or the audience snickering, or the like), therein modifying thresholds and preferences of threshold and preference data 242 and/or updating rules of a model controlling controller 110 actions accordingly.

Machine learning techniques 246 can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques. Specifically, machine learning techniques 246 can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning algorithms.

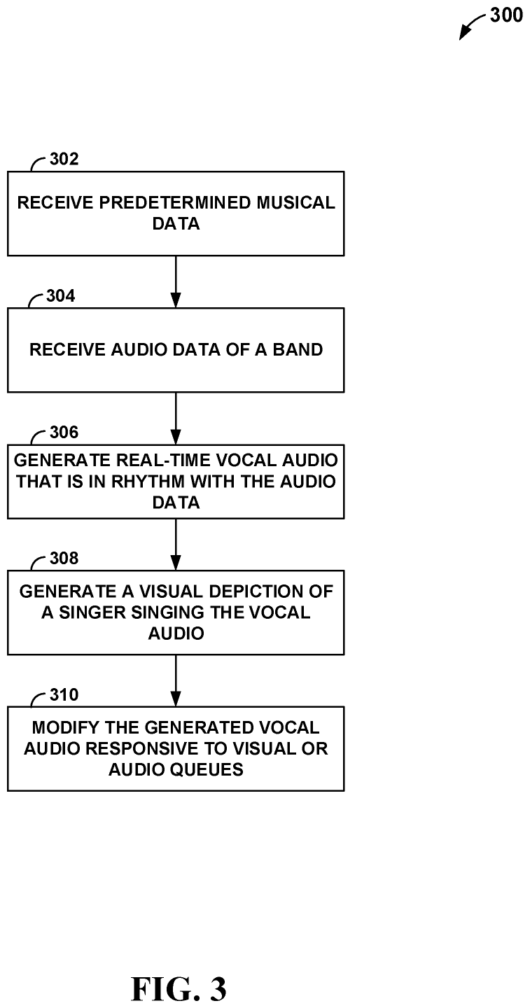

Using these components, controller 110 may generate real-time responsive vocal data as discussed herein. For example, controller 110 may respond to audio and visual data of a band in generating synchronized vocal data according to flowchart 300 depicted in FIG. 3. Flowchart 300 of FIG. 3 is discussed with relation to FIG. 1 for purposes of illustration, though it is to be understood that other environments with other components may be used to execute flowchart 300 of FIG. 3 in other examples. Further, in some examples controller 110 may execute a different method than flowchart 300 of FIG. 3, or controller 110 may execute a similar method with more or less steps in a different order, or the like.

Controller 110 receives predetermined musical data for a song (302). The predetermined musical data includes chords and lyrics and rhythmic structures of the song. In some examples, the predetermined musical data also includes certain tolerances, such as places where the music of the song is strictly followed and other times were one or more members of the band may improvise.

In some examples, receiving the predetermined musical data for a song may include receiving historical recordings of the song. Controller 110 may then ingest these historical vocal recordings, such as recording of this particular song by a particular band, involving a particular singer, or the like. Controller 110 may then generate a vocal profile of that particular singer. This vocal profile may include a timbre of the voice, certain proclivities of that singer (how and/or whether they liked to hold notes, if they would “swoop” up to notes or arrive at notes perfectly on pitch, whether the singer tended to be sharp or flat in general or for specific songs, how the singer used vibrato, etc.).

Controller 110 receives audio data of a band generating music of the song (304). Controller 110 receives this via one or more microphones 120 at a venue. Controller 110 may receive this audio data as live audio data, such that the band is playing as controller 110 receives the audio data.

Controller 110 generates real-time vocal audio (306). Controller 110 generates the real-time vocal data such that it is in rhythm with the audio data and in harmony with the chords. Controller 110 generates the real-time vocal data such that the vocal data includes the lyrics and is of a predetermined voice. Controller 110 may generate the vocal data such that the vocal data follows the chords of the predetermined musical data over time and synchronized with the band.

In some examples, controller 110 may generate the real-time vocal audio such that the real-time vocal audio matches the vocal profile of the particular singer (e.g., the singer of whose recordings controller 110 previously ingested). This may include controller 110 generating the real-time vocal audio to match the timbre, vibrato, and other stylistic/inherent qualities of the particular singer. For example, controller 110 may purposefully make the vocal audio be sharp or flat (e.g., not be directly on pitch) on a particular note or during a particular singing type of vocal flurry, if this is what the particular singer did on that note/vocal flurry.

The controller 110 generates a visual depiction of a singer that aligns with the vocal audio using graphical generation unit 150 (308). For example, controller 110 may generate the visual depiction such that it appears as if the visual depiction of the singer is singing the vocal audio live along with the band. In some examples graphical generation unit 150 is a screen, such that the visual depiction is a two-dimensional graphical representation of the singer. In other examples, graphical generation unit 150 includes hologram-generating technology, such that the visual depiction includes a hologram.

In some examples, controller 110 may generate instrumental audio that is in rhythm with the audio data and in harmony with the chords. Controller 110 may do this in addition to (or alternatively than) generating the vocal data. Controller 110 may further generate the visual depiction of the singer such that the singer is depicted playing an instrument. Specifically, controller 110 may depict the singer such that the singer is playing the instrument to output the instrumental audio such that it appears as if the visual depiction of the singer is playing the instrument to provide the instrumental audio. This may include the singer playing any relevant instrument, such as a guitar, piano, harmonica, or the like.

In some examples, controller 110 may receive visual data of the band. In such examples, controller 110 may generating the vocal data by modifying (in real-time) at least one of the chords, lyrics, or rhythmic structures of the song responsive to detecting a corresponding visual queue from the visual data (310). For example, controller 110 may detect a guitar player holding up an arm waiting to do a “down stroke” on the guitar, where the next chord or line of lyrics (or the like) is to be delivered once the guitar player plays this chord on the guitar.

In other examples, generating the vocal data includes modifying (in real-time) at least one of the chords or lyrics or rhythmic structures responsive to detecting a corresponding audible queue from the audio data. For example, controller 110 may slow down the pace, slow down the chord progression, and/or slow down the rhythm structure of the generated vocal data. Controller 110 may alter the pace in response to audible queues such as other members of the band slowing down, or a drummer hitting the drums to a relatively slower pace, or the like.

In some examples, controller 110 modifies the vocal data by identifying an improvisation element of the audio data of the band and modifying the vocal data to align with the improvisational element. This may include controller 110 detecting that a member of the band is improvising on an instrument, and accordingly delaying a next portion of the song at which the vocal data would be generated until this improvisational portion would end. Alternatively, this may include controller 110 generating an improvisational portion of vocal data and/or instrumental audio to align with the detected improvisational portion.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving predetermined musical data for a song, where the predetermined musical data includes chords and lyrics and rhythmic structures of the song;
receiving audio data of a band generating music of the song; and
generating real-time vocal audio that is in rhythm with the audio data and in harmony with the chords, wherein the vocal audio includes the lyrics and is of a predetermined voice.

2. The computer-implemented method of claim 1, wherein the vocal data follows the chords of the predetermined musical data over time synchronized with the band.

3. The computer-implemented method of claim 1, further comprising:
receiving visual data of the band, and
wherein generating the vocal data includes real-time modifying at least one of the chords or lyrics or rhythmic structures responsive to detecting a corresponding visual queue from the visual data.

4. The computer-implemented method of claim 1, further comprising generating a visual depiction of a singer that aligns with the vocal audio such that it appears as if the visual depiction of the singer is singing the vocal audio.

5. The computer-implemented method of claim 4, wherein the visual depiction includes a hologram.

6. The computer-implemented method of claim 5, further comprising:
generating instrumental audio that is in rhythm with the audio data and in harmony with the chords, and
wherein the generated visual depiction of the singer depicts the singer playing an instrument to output the instrumental audio such that it appears as if the visual depiction of the singer is playing the instrument to provide the instrumental audio.

7. The computer-implemented method of claim 1, wherein generating the vocal data includes real-time modifying at least one of the chords or lyrics or rhythmic structures responsive to detecting a corresponding audible queue from the audio data.

8. The computer-implemented method of claim 7, wherein the real-time modifying includes slowing down chord progression or rhythmic structure of the generated vocal data.

9. The computer-implemented method of claim 7, wherein the real-time modifying includes identifying an improvisation element of the audio data and modifying the vocal data to align with the improvisational element.

10. The computer-implemented method of claim 1, further comprising:
ingesting historical vocal data of a particular singer; and
generating a vocal profile of that particular singer,
wherein the predetermined voice is of the particular singer such that generating the real-time vocal audio includes generating the real-time vocal audio according to the vocal profile.

11. A system comprising:
a processor; and
a memory in communication with the processor, the memory containing instructions that, when executed by the processor, cause the processor to:
receive predetermined musical data for a song, where the predetermined musical data includes chords and lyrics and rhythmic structures of the song;
receive audio data of a band generating music of the song; and
generate real-time vocal audio that is in rhythm with the audio data and in harmony with the chords, wherein the vocal audio includes the lyrics and is of a predetermined voice.

12. The system of claim 11, wherein the vocal data follows the chords of the predetermined musical data.

13. The system of claim 11, the memory containing additional instructions that, when executed by the processor, cause the processor to:
receive visual data of the band, and
wherein generating the vocal data includes real-time modifying at least one of the chords or lyrics or rhythmic structures responsive to detecting a corresponding visual queue from the visual data.

14. The system of claim 11, the memory containing additional instructions that, when executed by the processor, cause the processor to generate a visual depiction of a singer that aligns with the vocal audio such that it appears as if the visual depiction of the singer is singing the vocal audio.

15. The system of claim 14, wherein the visual depiction includes a hologram.

16. The system of claim 15, the memory containing additional instructions that, when executed by the processor, cause the processor to:
generate instrumental audio that is in rhythm with the audio data and in harmony with the chords, and
wherein the generated visual depiction of the singer depicts the singer playing an instrument to output the instrumental audio such that it appears as if the visual depiction of the singer is playing the instrument to provide the instrumental audio.

17. The system of claim 11, wherein generating the vocal data includes real-time modifying at least one of the chords or lyrics or rhythmic structures responsive to detecting a corresponding audible queue from the audio data.

18. The system of claim 17, wherein the real-time modifying includes slowing down chord progression or rhythmic structure of the generated vocal data.

19. A computer program product, the computer program product comprising a computer readable storage medium having program instructions embodied therewith, the program instructions executable by a computer to cause the computer to:
receive predetermined musical data for a song, where the predetermined musical data includes chords and lyrics and rhythmic structures of the song;
receive audio data of a band generating music of the song; and
generate real-time vocal audio that is in rhythm with the audio data and in harmony with the chords, wherein the vocal audio includes the lyrics and is of a predetermined voice.

20. The computer program product of claim 19, wherein the vocal data follows the chords of the predetermined musical data.
